(19) United States
(12) Patent Application Publication
(10) Pub. No.: US 2025/0151047 A1
(43) Pub. Date: May 8, 2025

(54) SYSTEMS, METHODS, AND DEVICES FOR USING DCI TO INDICATE SCELL DORMANCY

(71) Applicant: Apple Inc., Cupertino, CA (US)

(72) Inventors: Ankit BHAMRI, Haar (DE); Haitong SUN, Saratoga, CA (US); Wei ZENG, Saratoga, CA (US); Dawei ZHANG, Saratoga, CA (US); Sigen YE, San Diego, CA (US); Huaning NIU, San Jose, CA (US); Chunxuan YE, San Diego, CA (US)

(21) Appl. No.: 18/933,958

(22) Filed: Oct. 31, 2024

Related U.S. Application Data
(60) Provisional application No. 63/596,054, filed on Nov. 3, 2023.

(51) Int. Cl. H04W 72/12; H04W 72/232

(52) U.S. Cl. CPC H04W 72/12; H04W 72/232

(57) ABSTRACT

The techniques described herein may include solutions for using downlink control information (DCI) to indicate dormancy for secondary cells (SCells). For DCI without a specific field for indicating dormancy for SCells, one or more fields of the DCI may be repurposed to report SCell dormancy. Repurposed fields may be arranged according to radio resource control (RRC) configuration information, a most significant bit (MSB), a least significant bit (LSB), and/or one or more bits being directed to specific SCell dormancy with one or more other bits being directed to SCell group dormancy, subsets of SCells, and/or a pre-defined rule. These and many other features and examples are described herein.

### CROSS-REFERENCE TO RELATED APPLICATIONS

This application claims the benefit of U.S. Provisional Application No. 63/596,054, filed Nov. 3, 2023, the content of which is incorporated herein by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve managing the operations and availability of base stations within the network.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview of using downlink control information (DCI) to indicate secondary cell (SCell) dormancy according to one or more implementations described herein.

FIG. 2 is a diagram of an example network according to one or more implementations described herein.

FIG. 3 is a diagram of an example of a master cell group (MCG) and a secondary cell group (SCG) according to one or more implementations described herein.

FIG. 4 is a diagram of an example process for using DCI to indicate SCELL dormancy according to one or more implementations described herein.

FIG. 5 is a diagram of an example of repurposing DCI fields to indicate SCell dormancy according to one or more implementations described herein.

FIG. 6 is a diagram of an example for using most significant bits (MSBs) and least significant bits (LSB) to indicate SCell dormancy according to one or more implementations described herein.

FIG. 7 is a diagram of an example for using groups of bits to indicate dormancy for SCells and SCell groups according to one or more implementations described herein.

FIG. 8 is a diagram of an example for using SCell subsets to indicate SCell dormancy according to one or more implementations described herein.

FIG. 9 is a diagram of an example for using SCell subset indexes to indicate SCell dormancy according to one or more implementations described herein.

FIG. 10 is a diagram of an example of components of a device according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include a UE providing base stations with capability information, the network determining how to configure the UE based on the capability information, the network providing the UE with configuration information, and the UE and base station communicating further in accordance with the configuration information.

In some scenarios, a UE may be connected with multiple cells simultaneously that may include a primary cell (PCell) and/or one or more secondary cells (SCell). The UE may gain initial access to the network via the PCell and may thereafter establish one or more connections with SCells. The UE may connect to the PCell via a primary component carrier (PCC) and to a SCell via secondary component carrier (SCC). Uplink (UL) data, as well as both control and user data, may be sent to the PCell via the PCC. In some implementations, the PCell may manage and/or enable connections between the UE and one or more SCells. For example, in some instances, one or more SCells may transition from an active state to a dormant state, and therefore become available to the UE. In such scenarios, the PCell may communicate control information (e.g., downlink control information (DCI)) to indicate whether one or more cells are to transition to dormancy.

A PCell (or an SCell) may use DCI to schedule and/or allocate physical resources for a physical downlink (DL) shared channel (PDSCH), a physical uplink (UL) shared channel (PUSCH), and/or to adjust UL transmission power used in a physical UL shared channel (PUSCH) or a physical UL control channel (PUCCH). DCI may correspond to one or more types of DCI, referred to as Type 0, Type 1, Type 2, etc. Type 0 may include a bitmap that indicates resource block groups (RBGs) allocated to the UE. An RBG may include a set of consecutive physical resource blocks (PRBs). Type 2 may include a bitmap that indicates PRBs, from a set of PRBs, from a subset of RBGs determined by system bandwidth. Type 2 may include a set of contiguously allocated physical or virtual resource blocks. The allocations vary from a single PRB to a maximum number of PRBs spanning the system bandwidth.

DCI may correspond to a DCI format, such as DCI format 0_0, DCI format 0_1, DCI format 1_0, etc. DCI format 0_0 may be used to schedule resources for a PUSCH; DCI format 1_0 may be used to schedule resources for a PDSCH; DCI format 2_0 may be used to notify a group of UEs about a slot format; and so on. As such, different formats of DCI may be used for different purposes and may include different fields and information. DCI fields may correspond to a type (e.g., Type 1A, Type 1B, Type 2, etc.). A Type 1A field may include a common field that may apply to all cells in a group of cells, while a Type 1B field may include a joint field that points to an index of a list comprising a combination of different values for cells in the group. A Type 2 field may include a field with multipole values corresponding to multiple cells, and a Type 3 field may include a configurable field, which may be configured by the network as a Type 1 or a Type 2 field.

The UE may provide the network (e.g., the PCell and/or SCell) with UE capability information indicating the communication capabilities of the UE. The network may determine radio resource control (RRC) configuration information based on the UE capability information and may send the RRC configuration information to the UE. The UE may determine, based on the RRC configuration information, what type of DCI is to be received from the PCell. More particularly, the UE may determine a type of DCI and a DCI format to be received from the PCell. This may be useful since DCI may be used to enable and/or disable connections between the UE and one or more SCells and because different types of DCI and different DCI formats may have different types, quantities, and arrangements of fields, which may carry different types, quantities, and arrangements of data.

DCI may include a specific field for explicitly indicating SCell dormancy. Such scenarios may involve the DCI being provided in accordance with a certain type of DCI format, such as DCI format 0_3. By contrast, in other scenarios, the DCI may not have a specific field for explicitly indicating SCell dormancy. Currently available technologies therefore fail to provide adequate solutions for indicating SCell dormancy using DCI because certain DCI formats (e.g., DCI 1_3) may not include a specific field for indicating SCell dormancy.

The techniques described herein may include one or more solutions to the deficiencies described above. For instance, one or more of the techniques described herein may enable an implicit indication of SCell dormancy by repurposing one or more DCI fields. Examples of such fields may include a field for indicating a modulation and coding scheme (MCS) of transport block 1, a field for indicating a new data indicator (NDI) of transport block 1, a field for indicating a redundancy version (RV) of transport block 1, a field for indicating a hybrid automatic repeat request (HARQ) process number, and/or a field for indicating one or more antenna port(s) when DCI Type 2 is applicable. These DCI fields may be repurposed to indicate SCell dormancy when DCI format 1_3 is used. In some implementations, the repurposing of the antenna port(s) field may vary depending on the number of configured SCells for which dormancy may need to be indicated. And the techniques described herein may include solutions for when and how to repurpose the antenna port field.

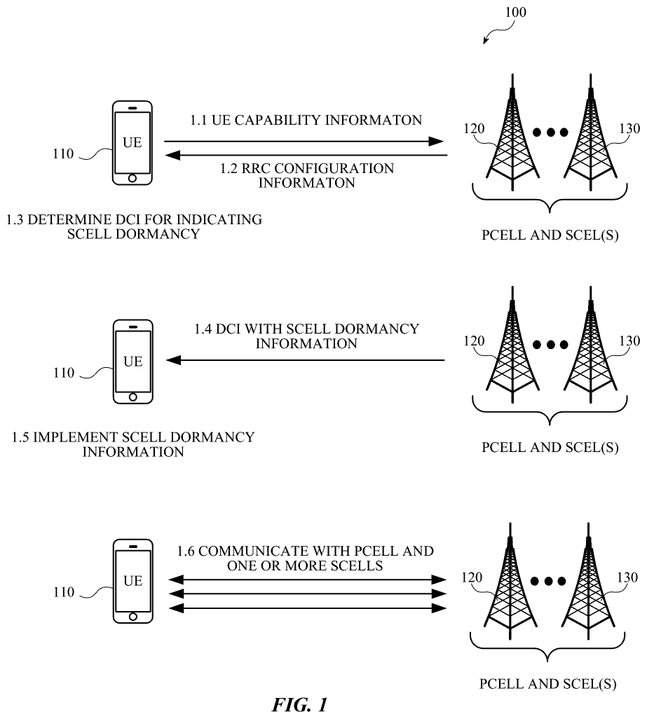

FIG. 1 is a diagram of an example of an overview 100 of using DCI to indicate SCell dormancy according to one or more implementations described herein. As shown, overview 100 may include UE 110, PCell 120, and one or more SCells 130. UE 110 may be capable of communicating with PCell 120 and SCells 130. UE 110 may communicate UE capability information to PCell 120 (at 1.1). The UE may receive RRC configuration information from PCell 120 (at 1.2) and may use the RRC configuration information to determine what type of DCI may be used PCell 120 to indicate dormancy information for SCells 130 (1.3).

UE 110 may determine that the DCI may not include a specific field for explicitly conveying the dormancy SCells 130. Instead, UE 110 may determine that one or more fields of the DCI may be repurposed to indicate SCell dormancy. This may enable UE 110 to properly receive the DCI since the size and arrangement of DCI may vary based on characteristics, such as a DCI format that is used, DCI field types, etc. UE 110 may receive DCI from PCell 120, which may include SCell dormancy information in repurposed DCI fields (at 1.4). The repurposed DCI fields may be of multi-cell scheduling DCI.

The SCell dormancy information may indicate that one or more SCells has, or will, transition from an active state of communication to a dormant state of communication. UE 110 may implement and/or update communications (e.g., communication channels, resource allocation, etc.) based on the SCell dormancy information (at 1.5) and may proceed to communicate with PCell 120 and one or more SCell in a manner consistent with the recently received SCell dormancy information. As such, one or more of the techniques described herein may enable DCI fields to be repurposed to communicate SCell dormancy information to UEs. While certain examples described herein may include PCell 120 using DCI to configure UE 110, which may include using repurposed DCI fields to indicate SCell dormancy, the techniques described herein may also include SCell 130 performing such operation. That is, SCell 140 may send to UE 110 RRC configuration information and/or DCI with repurposed DCI fields to indicate SCell scheduling. As such, operations performed by a PCell, as described herein, may also or alternatively be performed by an SCell.

Further, as described in additional detail below, the techniques described herein may include one or more additional solutions for repurposing DCI fields to indicate SCell dormancy. In one example, UE 110 may use RRC configuration information to create a bitmap, arranged by most significant bit (MSB) to least significant bit (LSB), based on the number and order of DormancyGroupIDs indicated in the RRC configuration information. The bits of the bitmap may be repurposed from fields in a field-specific order (e.g., MSC field, NDI field, RV field, HPN field, and antenna port field).

In another example, DCI fields may be repurposed by arranging the bits thereof to include M total bits. The first N bits, of the M bits, may be for indicating the dormancy of specified SCells, while the remaining bits of the M bits may indicate the dormancy of one or more SCell groups. The first bit of both the N bits and the M total bits may include a most significant bit (MSB), while a last bit of the N bits and a last bit of the M total bits may include a least significant bit (LSB). In yet other examples, SCell dormancy may be indicated in repurposed DCI fields based on SCells being arranged into subsets of SCells, and the subsets of SCells being associated with a subset index, UE capability information, and more. Accordingly, the techniques described herein include many examples and implementations for using DCI to indicate SCell dormancy.

When the antenna port field is configured as a Type 2 field for UE 210, there may be enough bits to indicate SCell dormancy via repurposed DCI fields. When the antenna port field is configured as another Type of field (e.g., Type 1A), then the antenna port field may not be available for repurposing, in which case the other fields (e.g., the MCS field, NDI field, RV field, and HPN field) may not have enough bits to indicate SCell dormancy via field repurposing. In such scenarios, therefore, additional or alternative solutions may be beneficial. Accordingly, one or more of the techniques described herein may involve indicating SCell dormancy via field repurposing when the antenna port field of UE is configured according to something other than Type 2. These and other features and examples are described below with reference to the Figures that follow.

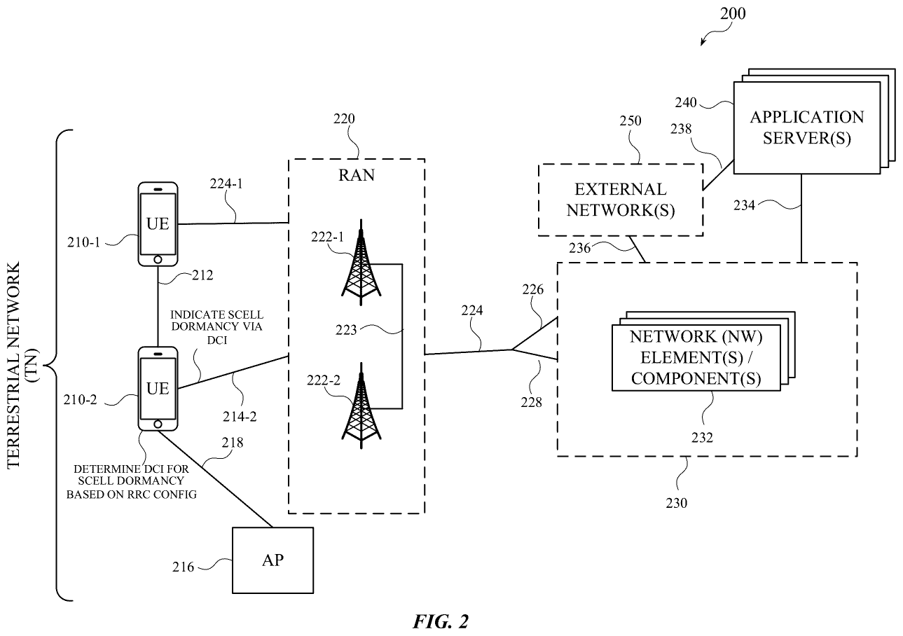

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222. In some scenarios, RAN 220 can coordinate with core network 230 via interfaces 224, 226, and/or 228.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques described herein may enable DCI to indicate dormancy for one or more SCells. For DCI without a specific field for indicating dormancy for SCells, one or more fields of the DCI may be repurposed to report SCell dormancy. Repurposed fields may be arranged according to RRC configuration information, a MSB, an LSB, and/or one or more bits being directed to specific SCell dormancy with one or more other bits being directed to SCell group dormancy, subsets of SCells, and/or a pre-defined rule. These and many other features and examples using DCI to indicate dormancy for one or more SCells are enabled by the description provided herein.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

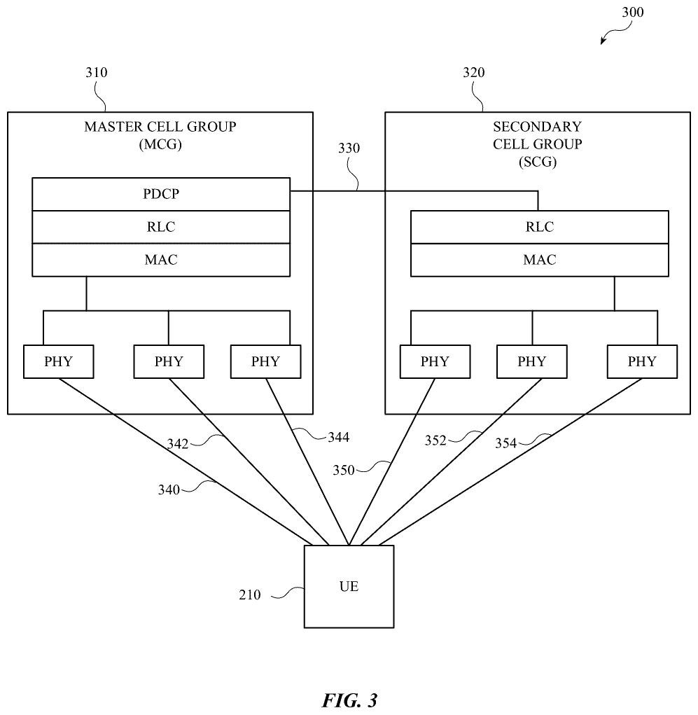

FIG. 3 is a diagram of an example 300 of a master cell group (MCG) 310 and a secondary cell group (SCG) 320 according to one or more implementations described herein. An MCG may include a group of cells associated with a master node, comprising a PCell and one or more SCells. An SCG may include a group of serving cells associated with a secondary node, comprising a primary cell of the secondary cell group (PSCell) and optionally one or more SCells. MCG 310 and SCG 320 may each be implemented by one or more base station 222 and/or another type of RAN node or access point.

MCG 310 may be implemented by one or more base stations and may include one or more layers. Examples of such layers may include a PDCP layer, an RLC layer, a MAC layer, and multiple PHY layers. Each PHY layer may correspond to a different implementation of a cell with respect to UE 210. Additionally, or alternatively, the PHY layers may operate in combination (e.g., be managed, controlled by, etc.) the PDCP, RLC, and MAC layers. In some implementations, one PHY layer 340 may operate as a PCell or a special cell (SpCell) and other PHY layers 342 and 344 may operate as SCells to the PCell.

SCG 320 may include multiple layers as well, including an RLC layer, a MAC layer, and multiple PHY layers 350, 352, and 354. SCG 320 may not include a PDCP layer, but instead may rely on the PDCP layer of MCG 310 via connection 330. Similar to the PHY layers of MCG 310, the PHY layers of SCG 320 may each function or operate as a cell with respect to UE 210. In some implementations, one PHY layer 350 may operate as a primary cell (PCell) to PHY layers 352 and 354, which may operate as secondary cells to the PCell of PHY layer 350. Additionally, MCG 310 and SCG 320 may each include a PCell (e.g., 340 and 350), and a PCell may be referred to herein as a special cell or special primary cell, represented as SpCell. Further, a SCell, of either MCG 310 or SCG 320, may operate as a scheduling secondary cell (sSCell) configured to provide configuration, scheduling, activation, deactivation, and other functions or commands toward a SpCell of either MCG 310 or SCG 320.

MCG 310 and SCG 320 may be involved in a dual connectivity scenario with UE 210, in which case a random access channel (RACH) procedure, and the like, may be directed to MCG 310. MCG 310 and SCG 320 may also implement a standalone (SA) and/or a non-standalone (NSA) network environment for UE 210. In a SA network environment, MCG 310 and SCG 320 may communicate with UE 210 using 5G NR communication standards. In an NSA network environment, MCG 310 and SCG 320 may communicate with UE 210 using a combination of 4G LTE and 5G NR communication standards. MCG 310 and/or SCG 320 may be configured to enable, support, and/or operate in accordance with the techniques described herein for using DCI to indicate SCell dormancy.

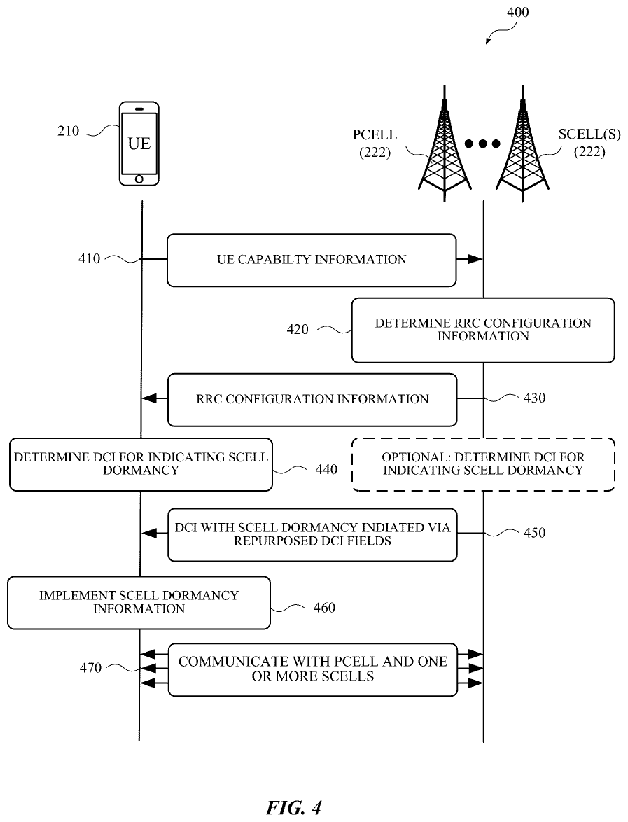

FIG. 4 is a diagram of an example process 400 for using DCI to indicate SCELL dormancy according to one or more implementations described herein. Process 400 may be implemented by UE 210 and base stations 222. As referenced herein, a PCell may include base station 222 operating as a PCell and/or MCG 310. An SCell may include base station 222 operating as an SCell and/or SCG 320. References to an SCell may also be applicable to SCG 320. Additionally, operation described as being performed by a PCell may also, or alternatively, be performed by one or more SCells.

In some implementations, some or all of process 400 may be performed by one or more other systems or devices, including one or more of the devices of FIG. 2. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or processes depicted in FIG. 4.

As shown, process 400 may include UE 210 sending UE capability information to PCell 222 (block 410). For example, UE 210 may provide a base station operating as PCell 222 with information about the capabilities of UE 210. This may include, for example, capabilities and/or services supported by UE 210 for communicating with one or roe base stations 222 and/or communicating within a network environment described herein. In some implementations, the UE capability information may relate to the ability of UE 210 to communicate with a PCell and one or more SCells 222. UE 210 may provide the UE capability information as part of an RRC attachment procedure or another type of procedure.

UE capability information may include an indication of whether UE 210 supports a repurposing of DCI fields that enable the indication of SCell dormancy. A repurposing of DCI fields to indicate SCell dormancy may be referred to as an implicit indication of SCell dormancy since DCI fields may be repurposed in order to do so. In some implementations, UE capability information may include an indication of whether UE 210 supports a repurposing of DCI fields to enable the indication of SCell dormancy if and/or when an antenna port field is not configured according to Type 2 (e.g., when the antenna port field is configured as Type 1A). In some implementations, UE configuration information may include an indication of a maximum number of SCells for which UE 210 may receive an indication of SCell dormancy via a repurposing of DCI fields. In some implementations, if or when the network (e.g., PCell 222) configures UE 210 to communicate with more SCells than is supported by UE 210, UE 210 may ignore one or indications of SCell dormancy. For example, UE 210 may ignore an indication of SCell dormancy for a number of SCells beyond the maximum number of SCells supported by UE 210.

Process 400 may include PCell 222 determining RRC configuration information (block 420). For example, a base station operating as a PCell for UE 210 may determine RRC configuration information for UE 210 based, at least in part, on UE capability information provided by UE 210. The RRC configuration information may include, for example, one or more instructions, parameters, and/or one or more other types of configuration information to enable UE 210 to communicate with PCell 222 and/or SCell 222. In some implementations, RRC configuration information may be referred to as higher layer information. A higher layer, in such a circumstance, may be relative to another type of configuration information, such as DCI.

Process 400 may include PCell 222 communicating RRC configuration information to UE 210 (block 430). For example, a base station operating as PCell 222 may provide UE 210 with RRC configuration information. The RRC configuration may include a wide variety of one or more types of information, including an indication of carriers, cells, resource allocations, scheduling information, and more. The RRC configuration may include information about PCell 222 and/or one or more SCells 222, information about DCI, a DCI format, and/or types of DCI information (e.g., Type 1A, Type 1B, Type 2, etc.). The RRC configuration may include information about PCell 222, one or more SCells 222, a total number of SCells 222, arrangements or subsets of SCells and/or SCell groups, and so on.

Process 400 may include UE 210 determining DCI for indicating SCell dormancy (block 440). For example, UE 210 may inspect and/or analyze the UE configuration information to determine one or more characteristics of DCI to be received from PCell 222. For example, UE 210 may determine whether PCell and/or one or more SCells may indicate SCell dormancy by repurposing one or more DCI fields. UE 210 may also, or alternatively, determine additional information about the indication of SCell dormancy according to one or more of the examples or implementations described herein. Examples of such information may include, or relate to, one or more DCI fields, one or more DCI formats, a type of DCI or DCI field, a concatenation of repurposed DCI fields to indicate SCell dormancy, a use of MSBs and/or LSBs indicate SCell dormancy, indicating SCell dormancy for individual SCells and/or SCell subsets, and so on. In some implementations, a base station operating as PCell 222 may also, or alternatively, determine one or more characteristics of DCI to be communicated to UE 210 based on UE configuration information and/or RRC configuration information.

Process 400 may also include UE 210 receiving DCI from a base station operating as PCell 222 (at 450). As described above, UE 210 may have determined one or more characteristics of the DCI prior to receiving the DCI. An example of such a characteristic may include whether the DCI would include a specific field for indicating SCell dormancy and/or whether the DCI would indicate SCell dormancy by repurposing one or more DCI fields. As described herein, the repurposed DCI fields may include an MCS, NDI, RV, HPN, and/or an antenna port(s) field. In some implementation, whether the antenna port(s) field is repurposed may be based on one or more factors, such as whether the antenna port(s) field is a Type 2 DCI field, a number of SCells for which dormancy is to be indicated, a DCI format being used, and/or one or more factors or conditions.

Process 400 may include UE 210 implementing SCell dormancy information (block 460). For example, UE 210 may configure or reconfigure communications with one or more SCells 222 based on the DCI information received from PCell 222. An indication of an SCell 222 being dormant or going dormant may involve the SCell 222 not being available to UE 210. As such, UE 210 may implement the cell dormancy information by discontinuing communications with one or more SCells 222, initiating communications with one or more SCells 222, altering ongoing communications with one or more SCells, etc. Implementing the SCell dormancy information may also, or alternatively, include updating one or more configuration parameters about which SCells are active, which SCells are dormant, which SCells correspond to which SCell subsets, a total number of SCells and/or SCell subsets in the network, etc. In some implementation, one or more of these updates may be based on RRC configuration information or a combination of RRC configuration and the DCI received from PCell 222.

Process 400 may include UE 210 comminating with PCells 222 and/or one or more SCells 222. For example, after UE 210 implements DCI indicating SCell dormancy via repurposed DCI fields, UE 210 may continue and/or proceed to communicate with PCell and one or more PCells. This may include UE 210 continuing to communicate with PCell 222 using existing UL and DL channels, communicating with one or more SCells 222 using one or more UL and DL channels, and/or establishing communications with one or more new or additional SCells 222. That is, the SCell dormancy information may cause, prompt, or otherwise enable UE 210 to discontinue communications with some SCells 222 and/or initiate communications with one or more other SCells 222. Accordingly, process 400 provides an example of repurposing DCI fields to indicate SCell dormancy according to one or more of the techniques described herein. Additional features, details, and examples of these techniques are discussed below with reference to the following Figures.

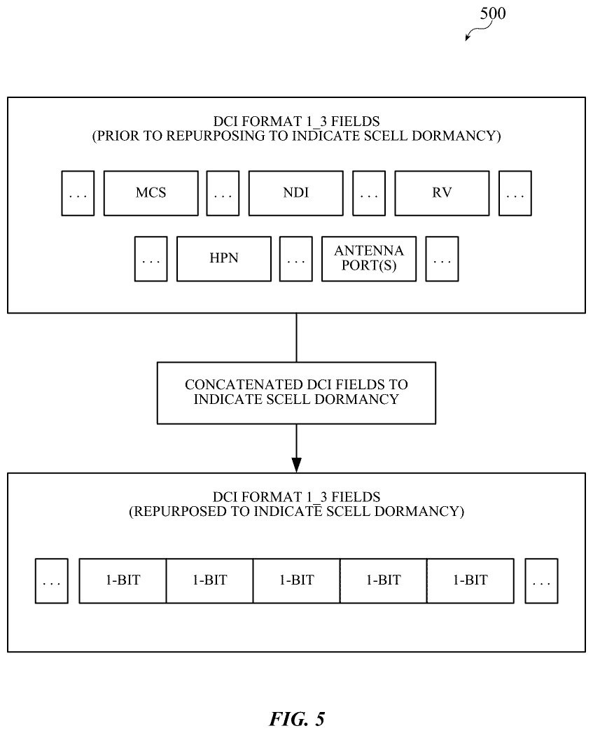

FIG. 5 is a diagram of an example 500 of repurposing DCI fields to indicate SCell dormancy according to one or more implementations described herein. As shown, DCI according to format 1_3 may include a variety of fields and information, including an MCS field, an NDI field, an RV field, an HPN field, and an antenna port field. In typical use and scenarios, a DCI format may not have the DCI fields arranged as physically or logically concatenated fields. For instance, an MCS field, an NDI field, an RV field, an HPN field, and an antenna port field may not be physically or logically adjacent in DCI format 1_3. However, according to one or more of the techniques described herein, non-adjacent DCI fields may be repurposed and rearranged to indicate SCell dormancy as concatenated fields.

Physically concatenating DCI fields may include resequencing or rearranging the fields of a DCI format, such that certain fields are transmitted and received as physically concatenated bits. In some implementations, logically concatenating DCI fields may include creating a logical association or map between physically separate DCI fields, such that the logical sequence in which the DCI fields are transmitted and received (with respect to one another) has significance, even though the bits of the logically concatenated DCI fields may not physically adjacent per se. That is, conceptually concatenating fields may be physically separated by other DCI fields but logically concatenated and sequency-specific (e.g., the MCS field may be a first SCell dormancy field, an NDI field may be as second SCell dormancy field, and so on).

Repurposed DCI fields may each include a 1-bit field, where a “1” may indicate that a SCell is active, while a “0” may indicate that a SCell is dormant. In some implementations, repurposed DCI fields may include additional information, such as information identifying which SCell corresponds to which DCI field. In other implementations, this information may be conveyed by implication (e.g., by a sequence of the DCI fields relative to how SCells are indicated in another DCI field, indicated in RRC configuration information, etc.)

In some implementations, a MSB and a LSB may be applied to repurposed DCI fields. In some implementations, the repurposed DCI fields may include an MCS field, an NDI field, an RV field, an HPN field, and an antenna port field, where the MCS field is a MSB on down to the LSB of the antenna port field. In other implementations, a different arrangement of DCI fields and MSB/LSB may be used. Accordingly, the techniques described herein may include repurposing DCI fields to indicate SCell dormancy, such that the repurposed DCI fields are concatenated and weighted according to MSB and LSB.

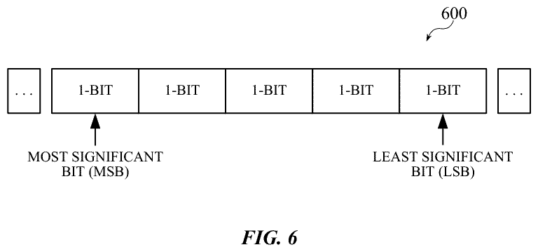

FIGS. 6-9 are diagrams of solutions for indicating SCell dormancy via repurposed DCI fields according to one or more implementations described herein. Generally, UE 210 may determine, based on RRC configuration information, characteristics about the DCI that the PCell 222 may send to the UE 210. Examples of such characteristics may include a DCI format, a type of one or more DCI fields, etc. With respect to SCell dormancy, UE 210 may determine that the DCI may include a specific field to explicitly indicate dormancy. An example of this may include a scenario in which UE 210 is configured with DCI 0_3. Alternatively, UE 210 may determine that the DCI may not have a specific field for indicating SCell dormancy. For example, DCI 1_3 may not have a specific field for indicating SCell dormancy. As such, the fields of DCI 1_3 may be repurposed so that SCell dormancy may be indicated. Examples of one or more DCI fields that may be repurposed may include an MCS field, an NDI field, an RV field, an HPN field, and an antenna port field.

The techniques described with reference to FIGS. 6-8 may apply to one or more scenarios. In one example, one or more of the techniques of FIGS. 6-8 may be implemented when the antenna port field for UE 210 is not configured as a Type 2 field. In another example, one or more of the techniques of FIGS. 6-8 may be implemented regardless of whether the antenna port field for UE 210 is configured as a Type 2 field. In yet another example, one or more of the techniques of FIGS. 6-8 may be implemented when the antenna port field for UE 210 is not configured as a Type 2 field and the number of SCells that may be indicated as dormant is less than (or equal to) the number of bits made available by repurposing the remaining fields (e.g., the MCS field, NDI field, RV field, and HPN field). While the examples of FIGS. 6-9 may include fields and bitmaps of a depicted quantity and arrangement, one or more of the techniques described herein may include a different quantity and/or arrangement of fields and bitmaps.

FIG. 6 is a diagram of an example 600 for using MSBs and LSB to indicate SCell dormancy according to one or more implementations described herein. RRC configuration information may include a dormancyGroup WithinActiveTime information element (IE) configured to indicate one or more DormancyGroupIDs. As a DormancyGroupID may correspond to an SCell or SCell group, UE 210 may use the number of DormancyGroupIDs to determine the number of bits (e.g., 1, 2, 3, 4, or 5 bits) that may be repurposed to convey SCell dormancy. The order in which DormancyGroupIDs are presented via dormancyGroupWithinActiveTime may cause UE 210 to determine a corresponding bitmap, where the first bit is a most significant bit (MSB) and a last bit is a least significant bit (LSB). Thus, DormancyGroupIDs may be mapped from MSB to LSB by concatenating bits from DCI fields in the following order: MSC field, NDI field, RV field, HPN field, and antenna port field. In some implementations, an additional or alternative order of fields may be used, and in some. Implementations, the antenna port field may not be used. Additionally, or alternatively, bits among the concatenated or repurposed fields may be reserved or set to a default value (e.g., a “0” or “1”).

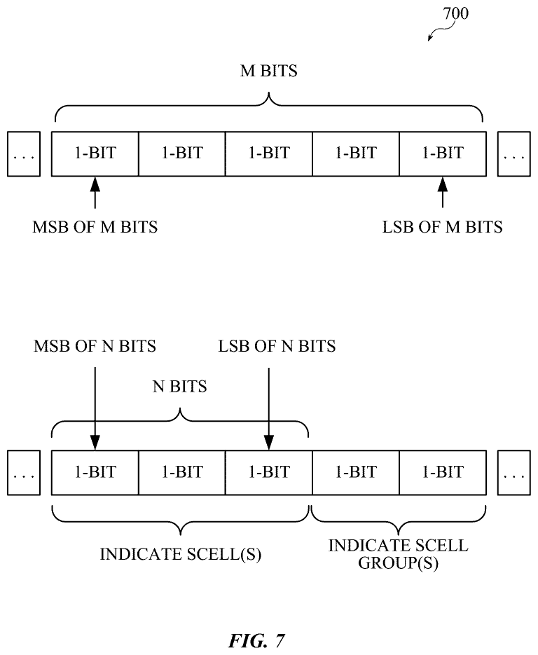

FIG. 7 is a diagram of an example 700 for using groups of bits to indicate dormancy for SCells and SCell groups according to one or more implementations described herein. As shown, repurposed or concatenated DCI fields may include a bitmap with a total number of M bits having a subset of N bits. The M bits and N bits may be arranged from a MSB to a LSB. The N bits (MSBs) may be used to indicate the dormancy of a first number of N SCells. The remaining bits (M bits minus N bits) may be used to indicate one or more SCGs configured by higher layers or RRC parameter dormancyGroup WithinActiveTime. The SCGs may be mapped to the remaining bits, with a MSB to LSB of the bitmap corresponding to the first to the last configured SCG (in ascending order of DormancyGroupID) and the determined bits are mapped from MSB to LSB by concatenating (if needed) the 1-bit fields. In some implementations, SCGs may be configured such that they include only SCells that cannot be indicated within the M bits (MSBs).

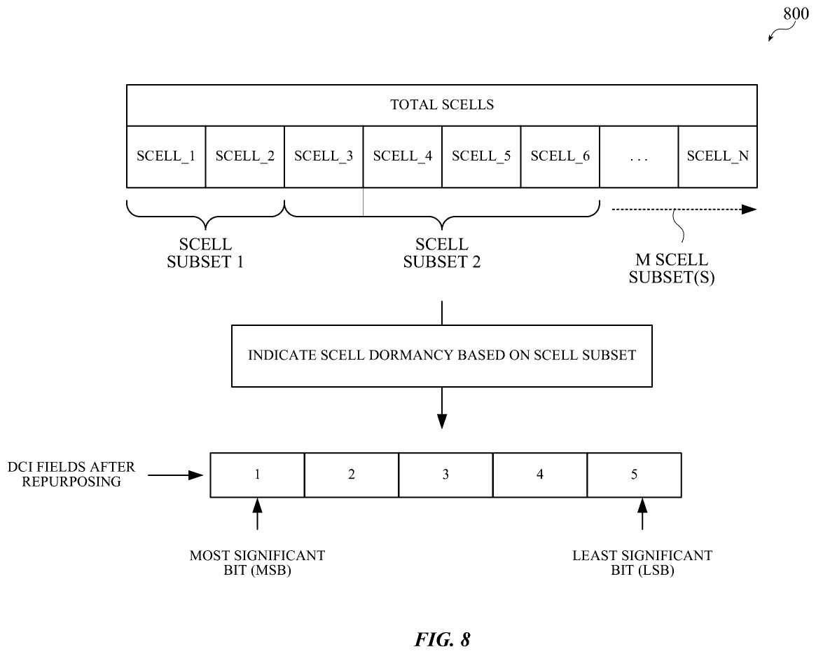

FIG. 8 is a diagram of an example 800 or using subsets of SCell to indicate SCell dormancy according to one or more implementations described herein. As shown, the SCells for which dormancy may be indicated via repurposed DCI fields may be configured or arranged into one or more subsets (e.g., SCell subset 1, SCell subset 2, etc.). In some implementations, the number of SCells in a subset may not exceed the total number of bits that may be used by repurposing and concatenating DCI fields as described herein. In some implementations, the SCells for which dormancy may be indicated via repurposed DCI fields may be determined based on a pre-determined rule. An example of such a rule. An example of such a rule may include a first number M of SCells within a subset of SCells being indicated. Another example of such a rule may include a last number M of SCells within a subset of SCells being indicated. In some implementations, one or more additional or alternative rules may be applied, including the use of MSB or LSB to select SCells within a subset of SCells.

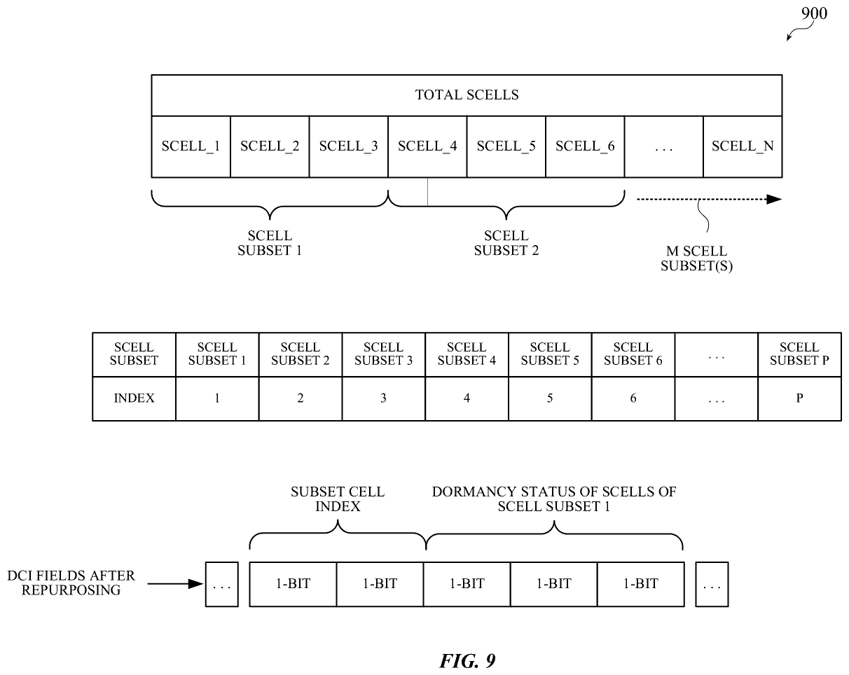

FIG. 9 is a diagram of an example 900 for using SCell subset indexes to indicate SCell dormancy according to one or more implementations described herein. As shown, the SCells for which dormancy may be indicated via repurposed DCI fields may be configured or arranged into one or more subsets (e.g., SCell subset 1, SCell subset 2, etc.). Each subset of SCell may be associated with an index (e.g., 1, 2, 3, etc.). In such scenarios, the first number of X bits from the repurposed and/or concatenated DCI fields may be used to indicate the index associated with a subset of SCells. A remaining number of Y bits may be used to indicate a dormancy status for each SCell of the indicated subset of SCells. The number of X bits may depend on the number of configured SCell subsets and/or a number of SCell subset indexes.

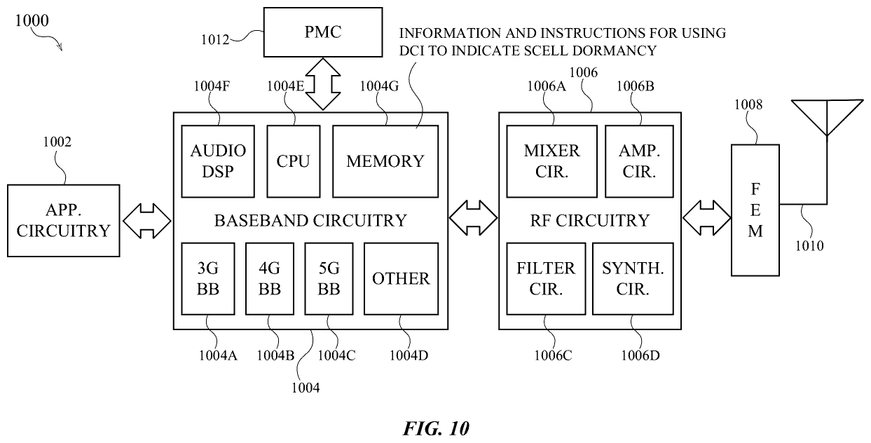

FIG. 10 is a diagram of an example of components of a device according to one or more implementations described herein. In some implementations, device 1000 can include application circuitry 1002, baseband circuitry 1004, RF circuitry 1006, front-end module (FEM) circuitry 1008, one or more antennas 1010, and power management circuitry (PMC) 1012 coupled together at least as shown. In some implementations, device 1000 can include fewer elements (e.g., a RAN node may not utilize application circuitry 1002 and can instead include a processor/controller to process data received from a core network. In some implementations, device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for cloud-RAN (C-RAN) implementations).

Application circuitry 1002 can include one or more application processors. For example, application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 1000. In some implementations, processors of application circuitry 1002 can process data packets received from a core network.

Baseband circuitry 1004 can include circuitry such as, but not limited to, one or more single-core or multi-core processors. Baseband circuitry 1004 can include one or more baseband processors or control logic to process baseband signals received from a receive signal path of RF circuitry 1006 and to generate baseband signals for a transmit signal path of RF circuitry 1006. Baseband circuity 1004 can interface with application circuitry 1002 for generation and processing of the baseband signals and for controlling operations of RF circuitry 1006. For example, in some implementations, baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 5G, 6G, 7G, etc.). Baseband circuitry 1004 (e.g., one or more of baseband processors 1004A-D) can handle various radio control functions that enable communication with one or more radio networks via RF circuitry 1006. In other implementations, some or all of the functionality of baseband processors 1004A-D can be included in modules stored in memory 1004G and executed via a central processing unit (CPU) 1004E. The radio control functions can include, but are not limited to, signal modulation/demodulation, encoding/decoding, radio frequency shifting, etc. In some implementations, modulation/demodulation circuitry of baseband circuitry 1004 can include Fast-Fourier Transform (FFT), precoding, or constellation mapping/de-mapping functionality. In some implementations, encoding/decoding circuitry of baseband circuitry 1004 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 1004G may receive and/or store information and instructions for using DCI to indicate dormancy for one or more SCells. For DCI without a specific field for indicating dormancy for SCells, one or more fields of the DCI may be repurposed to report SCell dormancy. Repurposed fields may be arranged according to RRC configuration information, a MSB, a LSB, and/or one or more bits being directed to specific SCell dormancy with one or more other bits being directed to SCell group dormancy, subsets of SCells, and/or a pre-defined rule. Information and instructions 1004G may enable these and many other features and examples are described herein.

In some implementations, baseband circuitry 1004 can include one or more audio digital signal processor(s) (DSP) 1004F. Audio DSP 1004F can include elements for compression/decompression and echo cancellation and can include other suitable processing elements in other implementations. Components of baseband circuitry 1004 can be suitably combined in a single chip, a single chipset, or disposed on a same circuit board in some implementations. In some implementations, some or all of the constituent components of baseband circuitry 1004 and application circuitry 1002 can be implemented together such as, for example, on a system on a chip (SOC).

In some implementations, baseband circuitry 1004 can provide for communication compatible with one or more radio technologies. For example, in some implementations, baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various implementations, RF circuitry 1006 can include switches, filters, amplifiers, etc., to facilitate the communication with the wireless network. RF circuitry 1006 can include a receive signal path which can include circuitry to down-convert RF signals received from FEM circuitry 1008 and provide baseband signals to baseband circuitry 1004. RF circuitry 1006 can also include a transmit signal path which can include circuitry to up-convert baseband signals provided by baseband circuitry 1004 and provide RF output signals to FEM circuitry 1008 for transmission.

In some implementations, the receive signal path of RF circuitry 1006 can include mixer circuitry 1006A, amplifier circuitry 1006B and filter circuitry 1006C. In some implementations, the transmit signal path of RF circuitry 1006 can include filter circuitry 1006C and mixer circuitry 1006A. RF circuitry 1006 can also include synthesizer circuitry 1006D for synthesizing a frequency for use by mixer circuitry 1006A of the receive signal path and the transmit signal path. In some implementations, mixer circuitry 1006A of the receive signal path can be configured to down-convert RF signals received from FEM circuitry 1008 based on the synthesized frequency provided by synthesizer circuitry 1006D. Amplifier circuitry 1006B can be configured to amplify the down-converted signals and filter circuitry 1006C can be a low-pass filter (LPF) or band-pass filter (BPF) configured to remove unwanted signals from the down-converted signals to generate output baseband signals. Output baseband signals can be provided to baseband circuitry 1004 for further processing. In some implementations, the output baseband signals can be zero-frequency baseband signals, although this may not be a requirement. In some implementations, mixer circuitry 1006A of the receive signal path can comprise passive mixers, although the scope of the implementations is not limited in this respect.

In some implementations, mixer circuitry 1006A of the transmit signal path can be configured to up-convert input baseband signals based on the synthesized frequency provided by synthesizer circuitry 1006D to generate RF output signals for FEM circuitry 1008. The baseband signals can be provided by baseband circuitry 1004 and can be filtered by filter circuitry 1006C. In some implementations, mixer circuitry 1006A of the receive signal path and mixer circuitry 1006A of the transmit signal path can include two or more mixers and can be arranged for quadrature down conversion and up conversion, respectively. In some implementations, mixer circuitry 1006A of the receive signal path and mixer circuitry 1006A of the transmit signal path can include two or more mixers and can be arranged for image rejection. In some implementations, mixer circuitry 1006A of the receive signal path and mixer circuitry 1006A can be arranged for direct down conversion and direct up conversion, respectively. In some implementations, mixer circuitry 1006 of the receive signal path and mixer circuitry 1006A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 1006 can include analog-to-digital converter (ADC) and digital-to-analog converter (DAC) circuitry and baseband circuitry 1004 can include a digital baseband interface to communicate with RF circuitry 1006.

In some dual-mode implementations, a separate radio integrated circuitry can be provided for processing signals for each spectrum, although the scope of the implementations is not limited in this respect. In some implementations, synthesizer circuitry 1006D can be a fractional-N synthesizer or a fractional N/N+1 synthesizer, although the scope of the implementations is not limited in this respect as other types of frequency synthesizers can be suitable. For example, synthesizer circuitry 1006D can be a delta-sigma synthesizer, a frequency multiplier, or a synthesizer comprising a phase-locked loop with a frequency divider.

Synthesizer circuitry 1006D can be configured to synthesize an output frequency for use by mixer circuitry 1006A of RF circuitry 1006 based on a frequency input and a divider control input. In some implementations, synthesizer circuitry 1006D can be a fractional N/N+1 synthesizer. In some implementations, frequency input can be provided by a voltage-controlled oscillator (VCO). Divider control input can be provided by either baseband circuitry 1004 or the applications circuitry 1002 depending on the desired output frequency. In some implementations, a divider control input (e.g., N) can be determined from a look-up table based on a channel indicated by the applications circuitry 1002.

Synthesizer circuitry 1006D of RF circuitry 1006 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 1006 can include an in-phase/quadrature (I/Q)/polar converter.

FEM circuitry 1008 can include a receive signal path which can include circuitry configured to operate on RF signals received from one or more antennas 1010, amplify the received signals and provide the amplified versions of the received signals to RF circuitry 1006 for further processing. FEM circuitry 1008 can also include a transmit signal path which can include circuitry configured to amplify signals for transmission provided by RF circuitry 1006 for transmission by one or more of the one or more antennas 1010. In various implementations, the amplification through the transmit or receive signal paths can be done solely in RF circuitry 1006, solely in FEM circuitry 1008, or in both RF circuitry 1006 and FEM circuitry 1008.

In some implementations, FEM circuitry 1008 can include a transmit/receive switch to switch between transmit mode and receive mode operation. FEM circuitry 1008 can include a receive signal path and a transmit signal path. The receive signal path of FEM circuitry 1008 can include a low noise amplifier to amplify received RF signals and provide the amplified received RF signals as an output (e.g., to RF circuitry 1006). The transmit signal path of FEM circuitry 1008 can include a power amplifier to amplify input RF signals (e.g., provided by RF circuitry 1006), and one or more filters to generate RF signals for subsequent transmission (e.g., by one or more of one or more antennas 1010).

In some implementations, PMC 1012 can manage power provided to baseband circuitry 1004. In particular, PMC 1012 can control power-source selection, voltage scaling, battery charging, or direct current (DC) to DC (DC-to-DC) conversion. PMC 1012 can often be included when device 1000 is capable of being powered by a battery, for example, when device 1000 is included in a UE. PMC 1012 can increase the power conversion efficiency while providing desirable implementation size and heat dissipation characteristics.

While FIG. 10 shows PMC 1012 coupled only with baseband circuitry 1004. However, in other implementations, PMC 1012 can be additionally or alternatively coupled with, and perform similar power management operations for, other components such as, but not limited to, application circuitry 1002, RF circuitry 1006, or FEM circuitry 1008.

In some implementations, PMC 1012 can control, or otherwise be part of, various power saving mechanisms of device 1000. For example, if device 1000 is in an RRC_Connected state, where device 1000 is still connected to the RAN node as device 1000 expects to receive traffic shortly, then device 1000 can enter a state known as discontinuous reception mode (DRX) after a period of inactivity. During this state, device 1000 can power down for brief intervals of time and thus save power.

If there is no data traffic activity for an extended period of time, then device 1000 can transition off to an RRC_Idle state, where device 1000 disconnects from the network and does not perform operations such as channel quality feedback, handover, etc. Device 1000 can go into a very low power state and device 1000 can perform paging where again device 1000 periodically can wake up to listen to the network and then power down again. Device 1000 may not receive data in this state; in order to receive data, device 1000 can transition back to RRC_Connected state.

An additional power saving mode can allow a device to be unavailable to the network for periods longer than a paging interval (ranging from seconds to a few hours). During this time, the device 1000 can be unreachable to the network and can power down completely. Any data sent during this time can incur a large delay and device 1000 can assume the delay is acceptable.

Processors of the application circuitry 1002 and processors of the baseband circuitry 1004 can be used to execute elements of one or more instances of a protocol stack. For example, processors of the baseband circuitry 1004, alone or in combination, can be used execute Layer 3, Layer 2, or Layer 1 functionality, while processors of the baseband circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

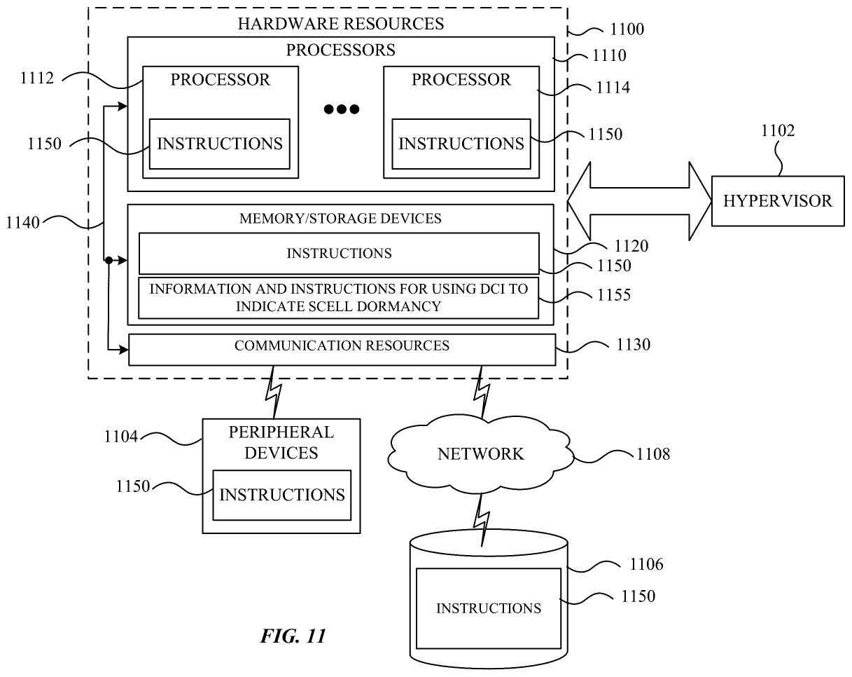

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors 1110 (or processor cores), one or more memory/storage devices 1120, and one or more communication resources 1130, each of which can be communicatively coupled via a bus 1140. For implementations where node virtualization or network function virtualization is utilized, a hypervisor can be executed to provide an execution environment for one or more network slices/sub-slices to utilize hardware resources 1100. Hardware resources 1100 can interact with hypervisor 1102. For example, hypervisor 1102 can schedule or otherwise manage hardware resource 1100.

Processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114.

In some implementations, memory/storage devices 1120 receive and/or store information and instructions 1155 for using DCI to indicate dormancy for one or more SCells. For DCI without a specific field for indicating dormancy for SCells, one or more fields of the DCI may be repurposed to report SCell dormancy. Repurposed fields may be arranged according to RRC configuration information, a MSB, a LSB, and/or one or more bits being directed to specific SCell dormancy with one or more other bits being directed to SCell group dormancy, subsets of SCells, and/or a pre-defined rule. Information and instructions 1155 may enable these and many other features and examples are described herein.

Communication resources 1130 can include interconnection or network interface components or other suitable devices to communicate with one or more peripheral devices 1104 or one or more databases 1106 via a network 1108. For example, communication resources 1130 can include wired communication components (e.g., for coupling via a universal serial bus), cellular communication components, near field communication components, Bluetooth® components (e.g., Bluetooth® Low Energy), Wi-Fi® components, and other communication components.

Instructions 1150A, 1150B, 1150C, 1150D, and/or 1150E can comprise software, a program, an application, an applet, an app, or other executable code for causing at least any of processors 1110 to perform any one or more of the methodologies discussed herein. Instructions 1150 can reside, completely or partially, within at least one of processors 1110 (e.g., within a cache memory), memory/storage devices 1120, or any suitable combination thereof. Furthermore, any portion of instructions 1150A-E can be transferred to hardware resources 1100 from any combination of peripheral devices 1104 or databases 1106. Accordingly, memory of processors 1110, memory/storage devices 1120, peripheral devices 1104, and databases 1106 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise a memory; and one or more processors configured to, when executing instructions stored in the memory, cause the UE to: receive, from a primary cell (PCell) of a network, radio resource control (RRC) configuration information; determine, based on the RRC configuration information, that downlink control information (DCI) to be received from the PCell is to include an indication of dormancy for at least one secondary cell (SCell) of the network via at least one repurposed DCI field of multi-cell scheduling DCI; receive, from the PCell, the DCI information; and communicate with the network according to the indication of dormancy for the at least one SCell.

In example 2, which may also include one or more of the examples described herein, the at least one secondary cell (SCell) comprises at least one SCell groups (SCG). In example 3, which may also include one or more of the examples described herein, the at least one repurposed DCI field comprises a repurposed field of DCI format 1_3. In example 4, which may also include one or more of the examples described herein, the at least one repurposed DCI field comprises at least one of: a field for a modulation and coding scheme for transport block 1; a field for a new data indicator of transport block 1; a field for a redundance version of transport block 1; and a field for a hybrid automatic repeat request (HARQ) process number. In example 5, which may also include one or more of the examples described herein, the UE is configured to determine a number of bits, of the at least one repurposed DCI field, to be used in the DCI to indicate the dormancy of the at least one SCell based on a number of DormancyGroupID parameters of the RRC configuration information.

In example 6, which may also include one or more of the examples described herein, a most significant (MSB) bit to a least significant (LSB), of the number of bits, is mapped to a first SCell indicated by a first DormancyGroupID parameter of the RRC to a last SCell indicated by a last DormancyGroupID parameter of the RRC. In example 7, which may also include one or more of the examples described herein, a number of fields, of the at least one repurposed DCI field, is based on a number of bits used to indicate the dormancy of the at least one SCell. In example 8,which may also include one or more of the examples described herein, unused bits, of the at least one repurposed DCI field, are reserved or set to a default value.

In example 9, which may also include one or more of the examples described herein, a first number of bits, of a total number of bits of the at least one repurposed DCI field, is configured to indicate dormancy for a number of SCells, a second number of bits, of a total number of bits of the at least one repurposed DCI field, is configured to indicate dormancy for at least one SCell group, and the at least one SCell group is indicated by a DormancyGroupID parameter of the RRC configuration information. In example 10, which may also include one or more of the examples described herein, the second number of bits comprises a remaining number of bits of the total number of bits and are map from a MSB to a LSB according to SCell groups indicated by multiple DormancyGroupID parameters of the RRC configuration information.

In example 11, which may also include one or more of the examples described herein, the indication of dormancy for the at least one SCell comprises an indication of dormancy for at least one subset of SCells. In example 12, which may also include one or more of the examples described herein, the indication of dormancy for the at least one SCell corresponds to a rule defining a maximum number of SCells, of a total number of SCells, for which dormancy is to be indicated. In example 13, which may also include one or more of the examples described herein, a number of bits of the at least one repurposed DCI field comprises: a first number of bits is configured to indicate an SCell subset of the at least one SCell; and a second number of bits is configured to indicate a dormancy for each SCell of the indicated SCell subset.

In example 14, which may also include one or more of the examples described herein, the UE is further configured to: communicate, to the PCell, UE capability information comprising an indication that the UE supports an indication of SCell dormancy via repurposed DCI fields when an antenna port field is not configured as a Type 2 field. In example 15, which may also include one or more of the examples described herein, the UE is further configured to: communicate, to the PCell, UE capability information comprising a maximum number of SCells for which SCell dormancy may be indicated via repurposed DCI fields. In example 16, which may also include one or more of the examples described herein, a base station may comprise: a memory; and one or more processors configured to, when executing instructions stored in the memory, cause the base station to: receive, from a user equipment (UE), UE capability information; and communicate, to the UE, downlink control information (DCI) comprising an indication of dormancy for at least one secondary cell (SCell) via repurposing at least one DCI field.

In example 17, which may also include one or more of the examples described herein, the base station is configured to operate as a primary cell (PCell) to the UE. In example 18, which may also include one or more of the examples described herein, the base station is further configured to: determine, based on the UE capability information, that the UE is capable of receiving the indication of dormancy for at least one SCell via repurposed DCI fields. In example 19, which may also include one or more of the examples described herein, the base station is further configured to: communicate, to the UE radio resource control (RRC) configuration information comprising dormancy information for at least one SCell.

In example 20, which may also include one or more of the examples described herein, the DCI corresponds to DCI format 1_3. In example 21, which may also include one or more of the examples described herein, a method, performed by a user equipment (UE), according to one or more of examples 1-20. In example 22, which may also include one or more of the examples described herein, a computer-readable medium, storing instruction configured to cause one or more processors to perform operations, the operations comprising one or more of claims 1-20

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
receive, from a primary cell (PCell) of a network, radio resource control (RRC) configuration information;
determine, based on the RRC configuration information, that downlink control information (DCI) to be received from the PCell is to include an indication of dormancy for at least one secondary cell (SCell) of the network via at least one repurposed DCI field of the DCI;
receive, from the PCell, the DCI including the indication of dormancy for the at least one SCell; and
communicate with the network according to the indication of dormancy.

2. The UE of claim 1, wherein the at least one secondary cell (SCell) comprises at least one SCell groups (SCG).

3. The UE of claim 1, wherein the at least one repurposed DCI field comprises a repurposed field of DCI format 1_3.

4. The UE of claim 1, wherein the at least one repurposed DCI field comprises at least one of:
a field for a modulation and coding scheme for transport block 1;
a field for a new data indicator of transport block 1;
a field for a redundance version of transport block 1; and
a field for a hybrid automatic repeat request (HARQ) process number.

5. The UE of claim 1, wherein the UE is configured to determine a number of bits, of the at least one repurposed DCI field, to be used in the DCI to indicate the dormancy of the at least one SCell based on a number of DormancyGroupID parameters of the RRC configuration information.

6. The UE of claim 5, wherein a most significant (MSB) bit to a least significant (LSB), of the number of bits, is mapped to a first SCell indicated by a first DormancyGroupID parameter of the RRC to a last SCell indicated by a last DormancyGroupID parameter of the RRC.

7. The UE of claim 1, wherein a number of fields, of the at least one repurposed DCI field, is based on a number of bits used to indicate the dormancy of the at least one SCell.

8. The UE of claim 7, wherein unused bits, of the at least one repurposed DCI field, are reserved or set to a default value.

9. The UE of claim 1, wherein:
a first number of bits, of a total number of bits of the at least one repurposed DCI field, is configured to indicate dormancy for a number of SCells,
a second number of bits, of a total number of bits of the at least one repurposed DCI field, is configured to indicate dormancy for at least one SCell group, and
the at least one SCell group is indicated by a DormancyGroupID parameter of the RRC configuration information.

10. The UE of claim 9, wherein the second number of bits comprises a remaining number of bits of the total number of bits and are map from a MSB to a LSB according to SCell groups indicated by multiple DormancyGroupID parameters of the RRC configuration information.

11. The UE of claim 10, wherein the indication of dormancy for the at least one SCell comprises an indication of dormancy for at least one subset of SCells.

12. The UE of claim 1, wherein the indication of dormancy for the at least one SCell corresponds to a rule defining a maximum number of SCells, of a total number of SCells, for which dormancy is to be indicated.

13. The UE of claim 1, wherein a number of bits of the at least one repurposed DCI field comprises:
a first number of bits is configured to indicate an SCell subset of the at least one SCell; and
a second number of bits is configured to indicate a dormancy for each SCell of the indicated SCell subset.

14. The UE of claim 1, wherein the UE is further configured to:
communicate, to the PCell, UE capability information comprising an indication that the UE supports an indication of SCell dormancy via repurposed DCI fields when an antenna port field is not configured as a Type 2 field.

15. The UE of claim 1, wherein the UE is further configured to:
communicate, to the PCell, UE capability information comprising a maximum number of SCells for which SCell dormancy may be indicated via repurposed DCI fields.

16. A base station, comprising:
a memory; and
one or more processors configured to, when executing instructions stored in the memory, cause the base station to:
receive, from a user equipment (UE), UE capability information; and
communicate, to the UE, downlink control information (DCI) comprising an indication of dormancy for at least one secondary cell (SCell) via repurposing at least one DCI field.

17. The base station of claim 16, wherein the base station is configured to operate as a primary cell (PCell) to the UE.

18. The base station of claim 16, wherein the base station is further configured to:
determine, based on the UE capability information, that the UE is capable of receiving the indication of dormancy for at least one SCell via repurposed DCI fields.

19. The base station of claim 16, wherein the base station is further configured to:
communicate, to the UE radio resource control (RRC) configuration information comprising dormancy information for at least one SCell.

20. A method, comprising:
receiving, from a primary cell (PCell) of a network, radio resource control (RRC) configuration information;
determining, based on the RRC configuration information, that downlink control information (DCI) to be received from the PCell is to include an indication of dormancy for at least one secondary cell (SCell) of the network via at least one repurposed DCI field of the DCI;
receiving, from the PCell, the DCI including the indication of dormancy for the at least one SCell; and
communicating with the network according to the indication of dormancy.
